(19) United States
(12) Patent Application Publication
(10) Pub. No.: US 2005/0200739 A1
(43) Pub. Date: Sep. 15, 2005

(54) Housing assembly for an image recording apparatus and method thereof

(75) Inventor: Kyoung-jin Ahn, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/045,141

(22) Filed: Jan. 31, 2005

(30) Foreign Application Priority Data
Mar. 10, 2004 (KR) 2004-16031

(51) Int. Cl. H04N 5/222

(52) U.S. Cl. 348/333.06

(57) ABSTRACT

A housing assembly for an image recording apparatus and method has an outer housing defining an outer side of the image recording apparatus, a liquid crystal display (LCD) monitor connected to the outer housing and foldable with respect to the outer housing, an inner cover, in combination with a display panel assembly, defining an interior portion of the image recording apparatus, and a plurality of component units affixed to the interior portion of the outer housing, with an operating part thereof being exposed outside of the outer housing. The LCD monitor and the component units share a fastening screw with the inner cover for the fastening thereof such that the LCD monitor and the component units are fastened to the outer housing with the inner cover by the common screw.

This application claims the benefit under 35 U.S.C. 119(a) of Korean Patent Application No. 2004-16031 filed Mar. 10, 2004, in the Korean Intellectual Property Office, the disclosure of which is incorporated herein by reference.

### BACKGROUND OF THE INVENTION

1. Field of the Invention

The present invention relates to an image recording apparatus and method thereof. More particularly, the present invention relates to a housing assembly for an image recording apparatus which requires a reduced number of fastening members such as fastening screws, and subsequently reduces the costs and amount of labor required for the assembly process.

2. Description of the Related Art

Typically, approximately more than 200 screws are required for the assembling of one image recording apparatus. The image recording apparatus includes therein a display unit, and also has respective board-mounted components such as a lens unit, terminals and controller, all of which are fastened to the housing of the image recording apparatus by fastening screws. While the number of components may be reduced, the number of required screws for the fastening of respective units is seldom changed.

The use of fastening screws is considered as one of the main factors that hinder the development of a compact and light-weight image recording apparatus. The fastening screw is generally made of steel, and requires manual labor especially in fastening the screws to the respective locations. This increases the amount of labor required, and burdens the worker especially as the screws become smaller in accordance with the miniaturization of the products. Therefore, a housing assembly of an image recording apparatus, which requires fewer fastening screws for the mounting of each component relative to the housing, is needed.

### SUMMARY OF THE INVENTION

Accordingly, the present invention has been made to solve the above-mentioned problems occurring in the related art, and an object of the present invention is to provide a housing assembly of an image recording apparatus and method, in which optimal arrangements are provided for the screw fastening of respective components and therefore requires a minimum number of screws for the mounting of the components.

In order to achieve the above aspects and/or other features of the present invention, a housing assembly for an image recording apparatus comprises an outer housing defining an outer side of the image recording apparatus; a liquid crystal display (LCD) monitor connected to the outer housing and foldable with respect to the outer housing; an inner cover, in combination with a display panel assembly, defining an inside of the image recording apparatus; and a plurality of component units fixed to the inner side of the outer housing, with an operating part thereof being exposed outside of the outer housing. The LCD monitor and the component units share a fastening screw with the inner cover for the fastening thereof such that the LCD monitor and the component units are fastened to the outer housing together with the inner cover by the common screw.

The component units comprise a function select key unit of the image forming apparatus; an external power source and input/output terminal unit; and a handle support bracket.

### BRIEF DESCRIPTION OF THE DRAWINGS

The above aspects and features of the present invention will be more apparent by describing certain embodiments of the present invention with reference to the accompanying drawings, in which:

FIG. 1 is a perspective view of an image recording apparatus according to an embodiment of the present invention; and

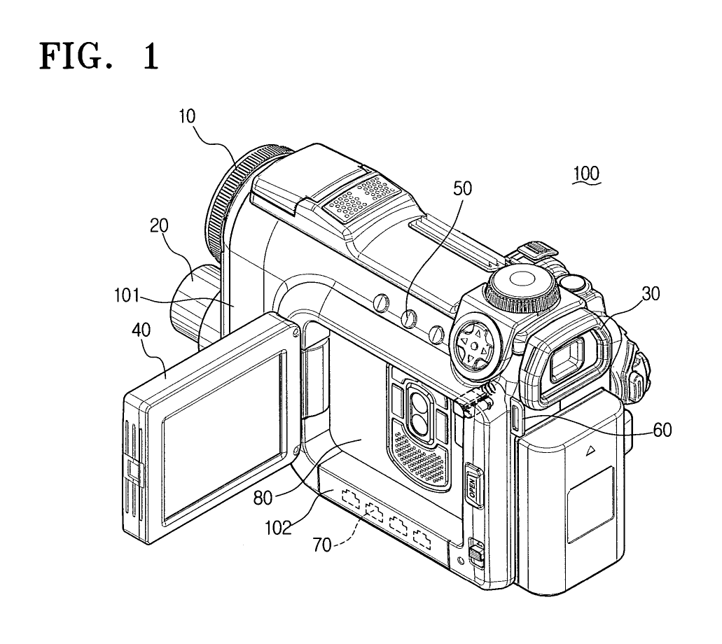

FIG. 2 is an exploded perspective view of a housing assembly of an image recording apparatus according to an embodiment of the present invention.

The same drawing reference numerals are used for the same elements throughout the drawings.

### DETAILED DESCRIPTION OF EXEMPLARY EMBODIMENTS

Certain embodiments of the present invention will now be described in greater detail with reference to the accompanying drawings.

The matters defined in the description such as a detailed construction and elements are exemplary. Thus, it should be apparent that the embodiments of the present invention can be performed without the specific examples used. Also, well-known functions or constructions are not described in detail since they would obscure the invention in unnecessary detail.

An image recording apparatus 100 according to an embodiment of the present invention comprises a digital video camera (DVC) 10 for photographing moving images, and a digital still camera (DSC) 20 for photographing still images. The DVC 10 and DSC 20 are mounted to the image recording apparatus 100 to face a forward direction. A viewfinder 30 is mounted to the rear side of the apparatus for the user to view the recorded images.

The image recording apparatus 100 also comprises an exemplary openable liquid crystal display (LCD) monitor 40 mounted to an outer housing 101, such that the user can check the images on the LCD monitor 40 while photographing the moving, or still images. It should be appreciated by those skilled in the art that although the embodiments of the invention are described as using an LCD monitor other types of monitors can be used without departing from the scope of the present invention.

A function select key unit 50 is outwardly protruded from the upper side portion of the outer housing 101. A handle support bracket 60, which supports a handle strap, and an external power source and input/output terminal unit 70 are also provided. Additionally, there is an openable cover 102 provided to open and close the external power source and input/output terminal unit 70.

The image recording apparatus 100 constructed according to the embodiment of the present invention has separate modules for the photographing of both moving images and high-resolution still images. Therefore, there is no need to separately buy a camcorder to photograph moving images and a camera to obtain high-resolution still images.

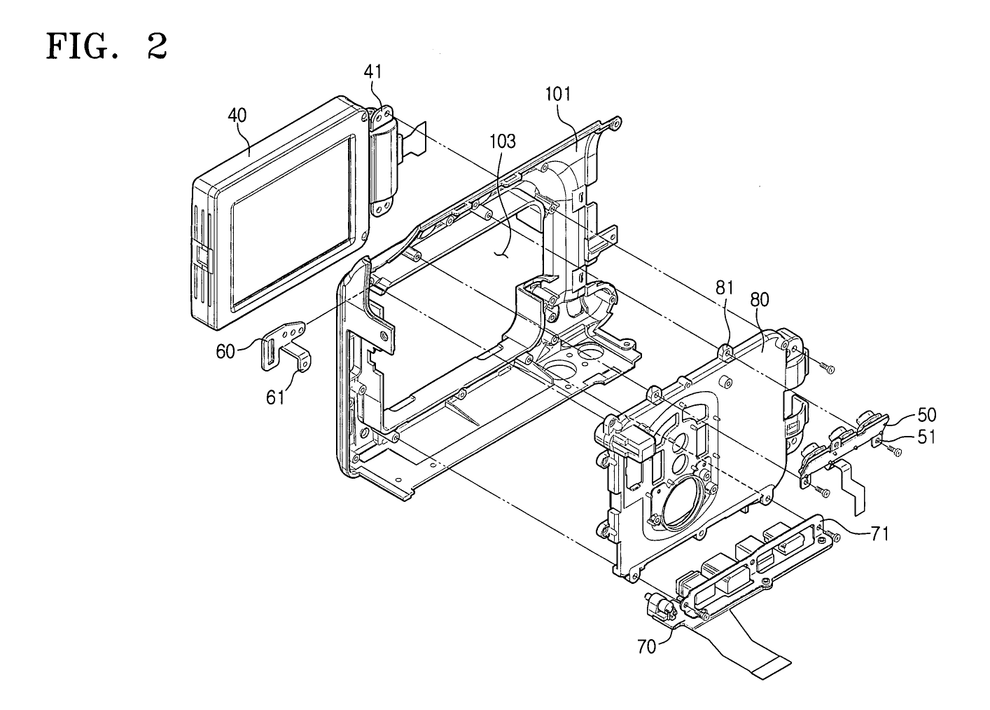

FIG. 2 is an exploded perspective view showing the outer housing 101 from a rear direction.

Referring to FIG. 2, a LCD seating opening 103 is defined in the outer housing 101 to receive the LCD monitor 40 when the LCD monitor 40 is folded. The LCD seating opening 103 is formed such that the LCD monitor 40 can be neatly seated inside the outer housing 101 and not protruding out of the outer housing 101. In order to prevent the possible exposure of the interior of the image recording apparatus 100 through the LCD seating opening 103, an inner cover 80 is provided to cover the LCD seating opening 103. The inner cover 80 defines the outside and inside of the outer housing 101.

Function keys or speakers may be provided in the inner cover 80. In other words, function keys for various additional functions of the image recording apparatus 100 may be formed on the inner cover 80, with the operating part of the function key being exposed to the outside when the LCD monitor 40 is open.

The LCD monitor 40, the function select key unit 50, the handle support bracket 60 and the external power source and input/output terminal unit 70 are fastened, together with the inner cover 80, to the rear side of the outer housing 101 by fastening screws. To this end, a LCD monitor fastening part 41, a function select key unit fastening part 51, a handle support bracket fastening part 61, and a fastening part 71 of the external power source and input/output terminal unit 70, are each located to correspond to an inner cover fastening part 81 which is fastened by screws for the secure mounting of the inner cover 80. The inner cover fastening part 81 is arranged along the outer circumference of the inner cover 80.

Therefore, between the rear side of the outer housing 101 and the inner cover 80, are the LCD monitor 40, the function select key unit 50, the handle support bracket 60 and the external power source and input/output terminal unit 70, arranged in their respective predetermined positions, and with the respective fastening parts in alignment with the inner cover fastening part 81. As a result, the respective units are all firmly fastened with the fastening of the inner cover 80.

In the construction as described above according to embodiments of the present invention, the number of fastening screws can be greatly reduced. Additionally, the amount of labor required for the assembling process is reduced, and the assembly time is reduced.

In the housing assembly for an image recording apparatus according to an embodiment of the preset invention, the screw-fastening parts of the respective components are provided in optimal arrangement, and therefore, a plurality of components can be fastened to the housing with the common fastening screws. As a result, the number of required fastening screws is reduced, the amount of time to assembly the apparatus is reduced, and the compactness of the product can be provided.

The foregoing embodiment and advantages are merely exemplary and are not to be construed as limiting the scope of the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A housing assembly for an image recording apparatus, comprising:
an outer housing defining an outer portion of the image recording apparatus;
a liquid crystal display (LCD) monitor connected to the outer housing and being foldable with respect to the outer housing;
an inner cover, in combination with a display panel assembly, defining an interior portion of the image recording apparatus; and
a plurality of component units affixed to the interior portion of the outer housing, with an operating part thereof being exposed outside the outer housing, wherein
the LCD monitor and the component units share a fastening screw with the inner cover for the fastening thereof such that the LCD monitor and the component units are fastened to the outer housing with the inner cover by the common screw.

2. The housing assembly according to claim 1, wherein the component units comprise:
a function select key unit of the image forming apparatus;
an external power source and input/output terminal unit; and
a handle support bracket.

3. The housing assembly according to claim 1, further comprising:
an LCD seating opening for accepting the LCD monitor within the outer housing.

4. The housing assembly according to claim 3, wherein the LCD seating opening is structured to allow the LCD monitor to fit substantially within the outer housing.

5. The housing assembly according to claim 3, wherein the LCD monitor does not protrude outside the outer housing.

6. The housing assembly according to claim 1, wherein the inner cover covers the LCD seating opening when the LCD monitor is in a closed position within the outer housing.

7. The housing assembly according to claim 1, further comprising:
an inner cover fastening part being in alignment with respective fastening parts of the LCD monitor, the external power source and the handle support bracket.

8. A method for connecting a housing assembly using a common screw for a image recording apparatus, comprising:
providing an outer housing defining an outer portion of the image recording apparatus;
connecting a liquid crystal display (LCD) monitor to the outer housing;
providing an inner cover, in combination with a display panel assembly, for defining an interior portion of the image recording apparatus;
affixing a plurality of component units to the interior portion of the outer housing, with an operating part thereof being exposed outside the outer housing; and
fastening the LCD monitor, the component units and the inner cover to the outer housing with a common fastening screw.

9. The method of claim 8, further comprising:
folding the LCD monitor with respect to the outer housing.

10. The method of claim 8, further comprising:
providing a function select key unit for selecting functions of the image forming apparatus;
providing an external power source for powering the image forming apparatus;
providing an input/output terminal unit for communicating with external devices; and
providing a handle support bracket for opening and closing the LCD monitor out of and into respectively the outer housing.

11. The method of claim 8, further comprising:
accepting the LCD monitor within the outer housing via an LCD seating opening.

12. The method of claim 11, further comprising:
structuring the LCD seating opening to allow the LCD monitor to fit substantially within the outer housing.

13. The method of claim 12, further comprising:
covering the LCD seating opening with the inner cover when the LCD monitor is in a closed position within the outer housing.

14. The method of claim 12, further comprising:
aligning an inner cover fastening part with respective fastening parts of the LCD monitor, the external power source and the handle support bracket.
